(19) United States
(12) Patent Application Publication
(10) Pub. No.: US 2002/0076530 A1
(43) Pub. Date: Jun. 20, 2002

(54) CAD/CAM blocks in the manufacture of dental materials

(76) Inventors: Joseph A. MacDougald, Madison, CT (US); Carlino Panzera, Hillsborough, NJ (US)

Correspondence Address: Jeneric/Pentron Inc., 53 North Plains Industrial Road, Wallingford, CT, 06492, US

(21) Appl. No.: 09/997,958

(22) Filed: Nov. 30, 2001

Related U.S. Application Data
(62) Division of application No. 09/432,283, filed on Nov. 2, 1999.

(51) Int. Cl. B32B 3/00

(52) U.S. Cl. 428/195

(57) ABSTRACT

Blocks or blanks of material comprise indicia to indicate the properties of the material. The blanks are designed for use in computer assisted milling machines whereby the machines can interpret the indicia and accomplish the milling process required for the blank being used. The milling process used will depend upon the information provided in the indicia. Preferably, the blocks are milled into shapes for use as dental restorations.

A milling machine is provided herein comprising an indicia-reading device for reading and interpreting the data provided on the block of material and carrying out the milling operation accordingly.

### FIELD OF THE INVENTION

The present invention relates generally to the manufacture of dental restorations using CAD/CAM methods and machines and more specifically to blocks of material for use in CAD/CAM methods and machines for the manufacture of dental restorations.

### BACKGROUND OF THE INVENTION

The fabrication of current all-ceramic dental restorations often requires extensive labor and time and the proficiency of highly skilled technicians. Many state-of-the-art dental restorations reveal a sense of artistry that can typically only be achieved manually or “by hand.” While aesthetics are preserved with this process, mivrostructural inhomogeneities may appear, affecting strength and reliability. The industry has attempted to automate this process by, for example, pressing crowns. Although pressable crowns reduce the time required to produce a crown, about two hours of concerted effort is necessary to complete a crown. Pressed crowns may also suffer from similar strength and reliability problems typical of “hand made” crowns.

Computer assisted design/computer assisted milling (CAD/CAM) processes and equipment have been recently introduced into the dental industry. In these processes, a three-dimensional image of a stump of a tooth is created along with the teeth surrounding the stump in an effort to create a dental restoration which is to be placed over the stump. This image is displayed on a computer screen. Based on the stump and surrounding teeth, the dental technician may then select a tooth from a plurality of tooth forms stored in the computer to best fit the stump. The selected tooth is projected onto the stump until an optimum positioning and fit of the dental restoration is achieved. The digital data concerning the dental restoration thus formed are supplied to a numerically controlled milling machine operating in three dimensions. The milling machine cuts a blank of no metal or porcelain material into the dental restoration design based on the data supplied.

U.S. Pat. No. 4,663,720 to Duret and commonly assigned U.S. Pat. No. 5,775,912 to Panzera et al. each teach CAD/CAM systems and materials which are designed to reduce labor and increase reliability and are herein incorporated by reference. U.S. Pat. No. 5,775,912 is directed to a method of making a dental restoration using soft-sintered porcelain pellets. The method requires the step of investing the tooth structure with an investment refractory material prior to fusing and fully densifying to contain the glass-ceramic which begins to flow during this step. The investment refractory material provides a mold to maintain the shape of the glass-ceramic during sintering.

Current materials used in CAD/CAM operations include ceramic, glass-ceramic, polymeric and composite material. Blanks for computer assisted milling machines may comprise different materials within the same blank to provide optimum strength and aesthetic properties. Moreover, blanks may vary by shape, size, color and material. The variety of materials, shapes, and properties can complicate the milling process and prolong the fabrication process. Milling equipment may only work with certain shapes or materials. For example, carbide cutting tools may work fine for porcelain, but may not be able to effectively cut alumina or zirconia. The tools may have to be reset for each blank, depending upon the material of the blank.

There is a need to reduce the time and labor involved in milling CAD/CAM blanks. It is desirable that the milling machines be adapted to handle a variety of materials. It would be beneficial if materials for use in milling machines be identifiable to the machine.

### SUMMARY OF THE INVENTION

These and other objects and advantages are accomplished by the materials herein comprising blocks of material, or blanks as they are often referred to, having indicia to indicate the properties of the material. The blanks are designed for use in computer assisted milling machines whereby the machines can interpret the indicia and accomplish the milling process required for the blank being used. The milling process used will depend upon the information provided in the indicia. Preferably, the blocks are milled into shapes for use as dental restorations.

In another embodiment herein, the milling process may require a specific material, shape, color or similar property in order to achieve the desired resultant product. Each block of material will be labeled with the properties in machine-readable format so that the machine can read and interpret the indicia and confirm whether the correct block is loaded in the machine. For example, if the color of the block installed in the machine does not match the color specified in the milling data for that specific milling operation, the machine will detect this and notify the operator of the error before the milling process begins. Errors will be prevented saving time, money and labor.

The indicia may include information regarding the type of material, shape of the blank, size, color, hardness and any other characteristic which will effect the type of milling required for that specific blank of material. The indicia may be in any form readable by the machine and/or by the operator of the machine. The indicia may be embossed or imprinted on the blank in the form of characters or codes. Alternatively, the indicia may be represented by the actual shape of the blank used in the process. As yet another option, the indicia may be in the form of colors or chemicals which the machine will recognize and interpret accordingly.

### BRIEF DESCRIPTION OF THE DRAWINGS

Features of the present invention are disclosed in the accompanying drawings. wherein similar reference characters denote similar elements throughout the several views, and wherein:

FIG. 1 is an elevational view of a block having a vertically aligned rectangular shape;

FIG. 2 is an elevational view of a block having a substantially square shape;

FIG. 3 is an elevational view of a block having a vertically aligned rectangular shape attached to a pedestal; and

FIG. 4 is an elevational view of a block having a substantially square shape attached to a pedestal.

### DESCRIPTION OF THE INVENTION

As will be appreciated, the present invention provides materials and methods designed for use with computer assisted milling machines to aid in the automation of the manufacturing process. Blanks of material are used in computer assisted milling machines in the fabrication of three-dimensional bodies. A variety of materials may be used to fabricate the blanks to provide the desired final product. For example, in the dental industry, blanks may be fabricated of ceramics, glass-ceramics, composites, polymeric materials, metals, alloys, and mixtures thereof. U.S. Pat. Nos. 5,939,211, 5,151,044, 4,970,032 and commonly assigned copending application Ser. No. 09/344,089 filed Jun. 25, 1999, are directed to blanks used in the manufacture of dental restorations and are hereby incorporated by reference. Dental restorations include but are not limited to orthodontic appliances, bridges, space maintainers, tooth replacement appliances, splints, crowns, partial crowns, dentures, posts, teeth, jackets, inlays, onlays, facing, veneers, facets, implants, abutments, cylinders, and connectors.

Blanks can be manufactured using a single material only or with a variety of different materials. If different materials are used, the blank may be manufactured by building layers of material upon one another. The layers may be fabricated of any material suitable for use as a dental restoration, such as those listed above. For example, a blank can be injection-molded by forming a core or central portion with a material that exhibits very high strength and is opaque. A layer of another material of different color and strength may be molded thereon, followed by a second layer of a different color and/or strength. The layers and colors of the materials correspond to and simulate the layers and colors found in natural teeth. In accordance herein, the blank may be inscribed or marked in some form with indicia, such as characters, to indicate what materials are present in the blank. It is preferable that the indicia is machine-readable in order for the machine to be able to detect and interpret the data and accordingly select the tools and programs necessary to be used with that specific blank. For example, a material such as zirconia may require diamond cutting tools vis a vis mullite which may be machined with carbide cutting tools. By marking the block of material with indicia indicating the proper cutting tools required, the machine and/or machine operator will retrieve the proper cutting tools for the material being machined. In this way, fewer or no errors will occur, providing a more efficient operation.

In another embodiment herein, blanks may include additional or other indicia specifying other properties of the blank to inform the machine as to what properties the blanks and/or material of the block. In typical milling operations, data is provided to the milling machine to guide it as it mills the desired shape. In addition to that data, in accordance herein, the milling machine may be provided with data specific to the final properties of the resultant milled product. For example, in addition to the data specifying the exact shape the product will have, color, translucency, and the like will be included in the data. Therefore, blanks will vary by shape, color, size, shade, translucency, thickness, strength, composition and those properties which distinguish one person's tooth from another's in addition to the properties which distinguish a person's canines, bicuspids and molars from one another. By identifying, for example, the shape of the block provided to the machine, the machine can determine if the shape is the optimal shape for the desired resultant product.

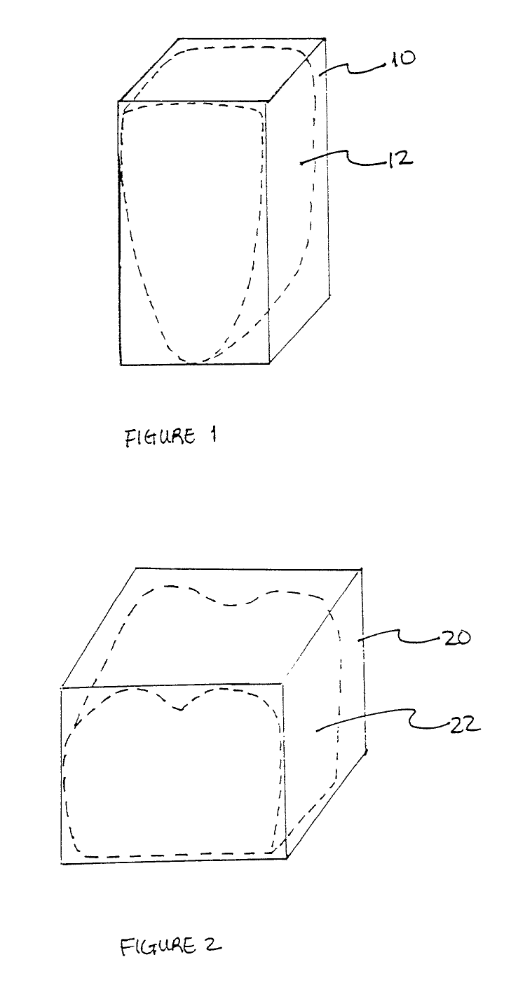

For example, if a crown for an incisor is required and the block inserted on the machine is designed for milling a crown for a molar, the machine will be able to recognize the shape of the block by the indicia thereon and alert the operator of the machine that the shape is inappropriate for this specific milling operation. FIG. 1 shows a block 10 having a vertically aligned rectangular shape. The block shape is designed to be used for machining restorations for teeth such as incisors which exhibit a narrow vertical shape. FIG. 1 shows the outline of a crown 12 machined from block 10. Crown 12 is a narrowly-shaped crown and substantially follows the shape of block 10. FIG. 2 shows a block 20 having a substantially square shape. The block shape is designed to be used for machining restorations for teeth such as molars which exhibit a square shape. An outline of a crown 22 is depicted in block 20 and fills a significant portion of block 20. In comparing block 10 to block 20, it is important to realize that the shape of the block used in machining three-dimensional bodies be appropriate for the shape of the resultant restoration. One would not want to use block 10 to machine crown 22 and likewise, one would not want to use block 20 to machine crown 12.

By identifying the shape and/or size of the block, inter alia, on the block itself, the milling machine can read and determine if the block positioned on the machine is appropriate for the specific milling operation it is about to undertake. Should a block similar to block 10 be positioned on a milling machine which is ready to begin the milling of a crown similar to crown 20, the machine will recognize the shape by the indicia thereon and alert the operator of the machine in some way such as for example, by rejecting the block or terminating the process.

This method applies not only to shape, but any property the blank or material may have which affects the final properties of the finally machined product. For example, in addition to the shape and size parameters of the product to be milled, the color and shade of the final product may be provided. In the dental industry, a vast array of shades and colors of porcelain and other materials exist for use in the fabrication of dental restorations to simulate the actual color and shade of a person's tooth. Accordingly, blocks of material may be provided in the vast array of shades and colors familiar to the dental industry. As the operator of the machine places the blank on the machine to begin the milling process, the machine will read the indicia on the block to determine whether the shade and color of the block are the same as that specified by the data provided to the machine for that particular milling operation. Accordingly, if the block on the machine does not coincide with the information specified for that milling operation, the machine will alert the operator prior to milling. Before the milling process begins, the operator is able to replace the block with the appropriate block specified in the milling data. This saves material and labor which would otherwise have been spent on having to perform the operation again.

As set forth herein, blocks or blanks for utilization in milling or machining devices are marked or labeled with indicia to indicate properties of the material. Indicia may be in the form of visually readable graphics/characters such as numeric, alphabetic, alpha-numeric, color-coding and/or a combination thereof, or in the form of machine readable graphics or characters such as in bar-codes, magnetic inks, electroconductive inks, optically scannable matrix symbols, and the like. Properties of the material may include, but are not limited to the chemical composition, size, shape and shade or color.

In a preferred embodiment, the blocks of the material are inscribed with the percentage of shrinkage the material will undergo during the sintering process to obtain the final product. This is particularly beneficial when the blocks to be machined are in the soft sintered or green state. In order for the final product to be accurately sized, the amount of shrinkage that will occur is necessary to determine at what size the block should be milled. Copending, commonly owned application Ser. No. 09/376,921 filed Aug. 18, 1999 is directed to methods of producing dental restorations using CAD/CAM techniques and is hereby incorporated by reference. The process involves milling unsintered or soft-sintered blocks of ceramic material into dental restorative shapes. Thereafter, the shapes are sintered to full density. It is critical to know the shrinkage of the material to determine the proper fit of the final restoration. For example, blocks of partially sintered alumina, zirconia, mullite, or combinations thereof, are machined to an oversized geometry. As set forth above, the oversizing is required to compensate for final shrinkage during the final sintering operation. The blocks of the materials do not always have the same starting densities. For example, a batch used to make one set of alumina soft sintered blocks may have a shrinkage of about 13%, in comparison to a different batch used to make alumina soft sintered blocks which exhibit a shrinkage of about 11%. It is imperative to know the exact amount of shrinkage in order to achieve final restorative materials having proper dimensions for an optimal fit. By marking the amount of shrinkage on the block of material, the milling machine and/or operator of the machine will know what dimensions to mill the block in order to achieve an accurate final fit.

The indicia may be located on the blank in a location whereby a sensor or like mechanism can detect and interpret the indicia. The indicia may be inscribed in any known matter and form. For example, the indica may be hot-stamped on the block during or after the forming process. The forming process involves known forming processes whereby the raw materials are mixed and molded into slabs of material. The slabs are then soft-sintered or fully sintered and thereafter cut into blocks of material suitable for the milling machine. At the sintering stage, a hot-stamping machine is used to stamp the indicia onto the block. The indicia is applied at a location which is consistent with the location of the indicia-readable device in the milling machine. When the block is inserted into the milling machine, the indicia will be aligned with the indicia-readable device for accurate conveyance.

In a preferred embodiment, the blocks are provided on block holders which comprise a pedestal or similar form having a platform. The block is attached to the platform by a bonding agent such as an epoxy resin. The block holder is made out of a durable material such a metal or plastic material. Preferably, the holder is fabricated of aluminum metal. If a holder is used, the indicia may be applied to the holder in any form applicable to metal, such as magnetic bar coding. The holder is inserted into the milling machine whereby the machine will have an indicia-readable device such as an optical scanner positioned proximate the location of the indicia on the holder. The scanner is able to read the data and process it by for example, selecting the proper cutting tools, registering the amount of shrinkage to determine the amount of milling to perform, and confirming the shade, color, and shape of the block. The data supplied to the machine is not limited to the above-specified examples and may be any data necessary to assist the machine in the milling operation.

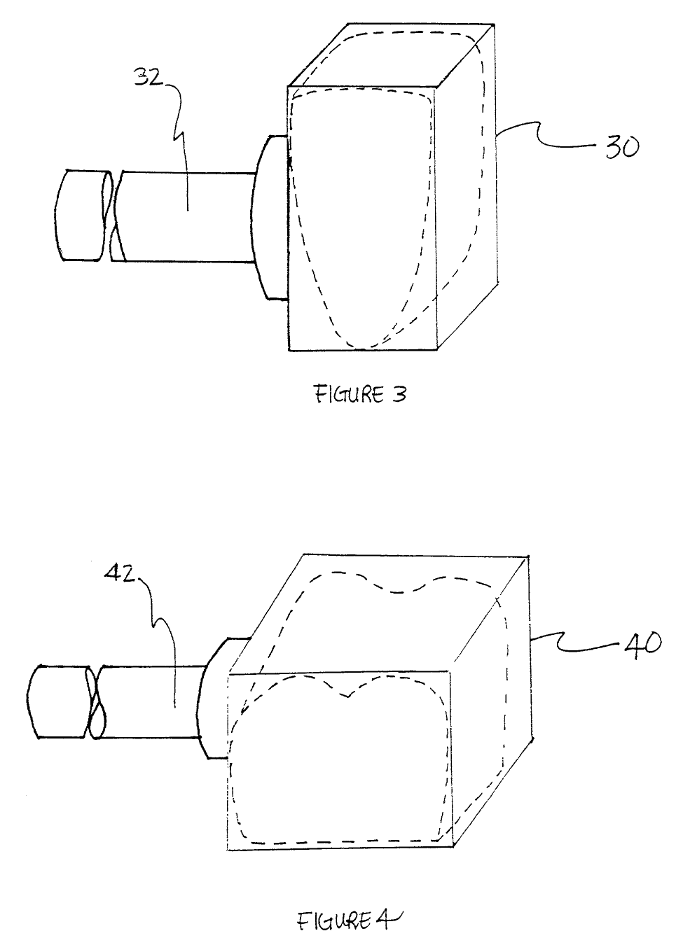

Indicia may be embossed, imprinted, inscribed or transformed on the blanks during manufacture or after manufacture of the blocks in a separate operation. Alternatively, matrix symbols may be applied to the blanks using ultrasound imaging techniques as described in U.S. Pat. No. 5,773,811 and hereby incorporated by reference. FIGS. 3 and 4 show blocks 30 and 40, respectively, having pedestals 32 and 42, respectively, attached thereto for inserting into a milling machine. Instead of inserting the block directly into the milling machine, the pedestal is inserted therein and positions and maintains the block in place for the duration of the milling process. The pedestal contains information relating to the block and milling operation which the machine reads and interprets accordingly. It is important that the milling machine is devised with an appropriate sensing mechanism to detect and read the indicia and process the information accordingly.

In an alternate embodiment herein, blanks of material are shaped differently depending upon the properties of the materials. For example the blanks having a cylindrical shape may be fabricated of alumina and blanks having a square shape may be formed of lithium disilicate. Each blank may require different cutting tools to provide the ideal final shape due to the differences in material properties. The milling machine would include a sensor to detect the blank shape and proceed with the milling operation accordingly. The shape of the blank could be formed during manufacture or alternatively, blanks of material of the same shape could be manufactured and thereafter, cut to the shape according to the properties of the material.

The following example illustrates the practice of the present invention.

### EXAMPLE

The information to be conveyed to the milling machine is inscribed on the pedestals shown in FIGS. 3 and 4 using a bar coding technique. The bar code may be printed on the pedestal using indelible permanent ink. The milling machine is equipped with an optical scanner. The scanner reads the bar code and transfers the information to the computer program. The program compares the information on the pedestal with the information entered by the technician, i.e., the color, translucency, hardness and the like. If the information on the block matches the information specified in the milling information input by the technician, the milling process is commenced. If the information does not match that input by the technician, the technician removes the block and inserts one that satisfies the information specified by the technician.

In the case of a soft-sintered block, the program sets the milling size based on the amount of shrinkage the fully sintered product will undergo. which amount is encrypted on the block or pedestal.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A block of material for machining comprising:
indicia on the block for identifying the properties of the block.

2. The block of claim 1 wherein the indicia is machine-readable.

3. The block of claim 2 wherein the machine-readable indicia enable a machine to read the indicia and carry out an operation based on information provided by the indicia.

3. The block of material of claim 1 for manufacturing dental restorations.

4. The block of material of claim 1 wherein the indicia comprise one or more characters to indicate properties of the material.

5. The block of material of claim 1 wherein the indicia comprise characters which indicate physical properties of the material.

6. The block of material of claim 1 wherein the indicia comprise characters which indicate chemical properties of the material.

7. The block of material of claim 1 wherein the indicia comprise characters which indicate aesthetic properties of the material.

8. The block of material of claim 4 wherein the properties include size, shade and composition of the material.

9. The block of material of claim 4 wherein the one or more characters is selected from numeric symbols, alphabetic symbols, alpha-numeric symbols, color symbols, bar-codes, optically scannable symbols and combinations thereof.

10. The block of material of claim 1 wherein the indicia are applied to the block with magnetic ink or electroconductive ink.

11. Materials for use in computer assisted milling machines comprising:
a series of blocks of material each having a different shape wherein the shape of the blocks correspond to properties of the materials of the blocks.

12. The materials of claim 11 wherein the shapes comprise cylinders, squares, and rectangles.

13. The materials of claim 11 wherein the properties are selected from composition, strength, hardness, shape, color, shade, and combinations thereof.

14. The block of claim 1 wherein the block is fabricated of a material selected from glass, glass-ceramic, ceramic, metal, polymeric, composite material, or mixtures thereof.

15. The block of claim 1 wherein the block is fabricated of alumina, zirconia, mullite, leucite, lithium disilicate, mica or mixtures thereof.

16. A machine for milling blocks of material into three-dimensional shapes comprising:
a sensor for detecting and reading indicia on the blocks, wherein said indicia comprises milling-related information.

17. The machine of claim 16 wherein the sensor is a scanner.

18. The machine of claim 16 wherein the machine mills dental restorative materials.

19. A machine for milling blocks of material into three-dimensional shapes comprising:
an indicia-reading device for detecting and reading indicia on the blocks, wherein said indicia comprises milling-related information.

20. A process for milling three-dimensional bodies comprising:
inserting a block of material onto a milling machine, wherein the block comprises indicia related to the milling of the block;
reading the indicia on the block;
carrying out the milling operation based on the indicia.
